(19) United States
(12) Patent Application Publication
(10) Pub. No.: US 2026/0051756 A1
(43) Pub. Date: Feb. 19, 2026

(54) POWER SYSTEMS FOR DATA CENTERS

(71) Applicant: Data Volt Information Technology Company, Riyadh (SA)

(72) Inventors: Andrea Lovato, Dubai (AE); Sangram Kunthia, Dubai (AE); Somen Mathur, Dubai (AE)

(21) Appl. No.: 19/048,639

(22) Filed: Feb. 7, 2025

Related U.S. Application Data
(60) Provisional application No. 63/682,589, filed on Aug. 13, 2024.

(51) Int. Cl. H02J 7/00; H01M 8/04082; H01M 8/0656; H01M 10/42; H01M 10/44; H01M 10/46; H01M 16/00; H02J 3/38

(52) U.S. Cl. CPC H02J 7/0068; H01M 8/04201; H01M 8/0656; H01M 10/425; H01M 10/44; H01M 10/46; H01M 16/006; H02J 3/381; H01M 2010/4271; H01M 2220/10; H01M 2250/10; H01M 2250/402; H02J 2300/24; H02J 2300/28; H02J 2300/30

(57) ABSTRACT

Systems and methods are described for powering a load, such as a data center, with renewable energy from a renewable energy source. When the renewable energy is greater than a demand of the load, excess renewable energy is used to power a hydrogen production device or charge a battery depending on whether or not the charge level of the battery satisfies an upper threshold charge level, respectively. When the renewable energy is less than the demand of the load and the charge level of the battery satisfies a lower threshold charge level, the load is powered with energy from the battery. When the renewable energy is less than the demand of the load and the charge level of the battery does not satisfy the lower threshold charge level, the load is powered and the battery is charged with energy generated by the hydrogen-based energy generator.

### CROSS-REFERENCE TO RELATED APPLICATIONS

This application claims priority to U.S. Provisional Patent Application No. 63/682,589, titled “POWER SYSTEMS FOR DATA CENTERS,” filed Aug. 13, 2024, the content of which is hereby incorporated by reference in its entirety.

### FIELD

The present disclosure relates generally to power systems, including electrical power systems and power systems for data centers.

### SUMMARY

Data centers, in conjunction with fiber cables, serve the growth of digital computing, including cloud-computing and generative artificial intelligence (AI). The increase in data generation, fueled in part by AI, creates demand for transformation in data processing, storage, management, and transfer, and leads to a heightened demand for computing power across data centers.

To accommodate significant increases in computing requirements for data centers, innovative cooling solutions are desired, alongside a substantial increase in electrical power consumption. However, data generation is constrained by the availability of the power supply for AI computing. Furthermore, the carbon footprint of the data center industry will continue to expand with increased data generation, resulting in a potentially significant environmental impact. Sustainable power generation, along with the construction of innovative, energy-integrated, circular, and more efficient data centers can help mitigate this impact.

Systems and methods of embodiments of the disclosure attempt to address these difficulties by providing a power system in which all the energy consumed by a data center is generated from renewable sources of energy (e.g., a Net Zero Data Center).

In accordance with some embodiments, a power system includes a renewable energy source, a battery energy storage system, a hydrogen production device, a hydrogen-based energy generator, and a load. The power system is configured to: generate renewable energy using the renewable energy source; power the load with the renewable energy generated by the renewable energy source when a set of conditions is satisfied; when the renewable energy is greater than a demand of the load: charge the battery energy storage system with the renewable energy generated by the renewable energy source when a charge level of the battery energy storage system does not satisfy an upper threshold charge level; and power the hydrogen production device with energy generated by the renewable energy source when the charge level of the battery energy storage system satisfies the upper threshold charge level; and when the renewable energy is less than the demand of the load: power the load with energy from the battery energy storage system when the charge level of the battery energy storage system satisfies a lower threshold charge level; and when the charge level of the battery energy storage system does not satisfy the lower threshold charge level: power the load with energy generated by the hydrogen-based energy generator; and charge the battery energy storage system with energy generated by the hydrogen-based energy generator.

In accordance with some embodiments, a method of operating a power system includes: generating renewable energy using a renewable energy source; powering a load with the renewable energy generated by the renewable energy source when a set of conditions is satisfied; when the renewable energy is greater than a demand of the load: charging a battery energy storage system with the renewable energy generated by the renewable energy source when a charge level of the battery energy storage system does not satisfy an upper threshold charge level; and powering a hydrogen production device with energy generated by the renewable energy source when the charge level of the battery energy storage system satisfies the upper threshold charge level; and when the renewable energy is less than the demand of the load: powering the load with energy from the battery energy storage system when the charge level of the battery energy storage system satisfies a lower threshold charge level; and when the charge level of the battery energy storage system does not satisfy the lower threshold charge level: powering the load with energy generated by a hydrogen-based energy generator; and charging the battery energy storage system with energy generated by the hydrogen-based energy generator.

In accordance with some embodiments, a control system includes one or more processors, memory; and one or more programs. The one or more programs are stored in the memory and configured to be executed by the one or more processors. The one or more programs include instructions for: causing powering of a load with renewable energy generated by a renewable energy source when a set of conditions is satisfied; when the renewable energy is greater than a demand of the load: causing charging of a battery energy storage system with the renewable energy generated by the renewable energy source when a charge level of the battery energy storage system does not satisfy an upper threshold charge level; and causing powering of a hydrogen production device with energy generated by the renewable energy source when the charge level of the battery energy storage system satisfies the upper threshold charge level; and when the renewable energy is less than the demand of the load: causing powering of the load with energy from the battery energy storage system when the charge level of the battery energy storage system satisfies a lower threshold charge level; and when the charge level of the battery energy storage system does not satisfy the lower threshold charge level: causing powering of the load with energy generated by a hydrogen-based energy generator; and causing charging of the battery energy storage system with energy generated by the hydrogen-based energy generator.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors. In some embodiments, these functions are performed in customized circuitry (e.g., processors and/or memory) and/or general purpose circuitry programed to perform the features.

Other aspects and advantages of embodiments of the disclosure will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 is a schematic diagram illustrating power system in accordance with embodiments of the disclosure;

FIG. 2 is a block diagram illustrating a power control system in accordance with embodiments of the disclosure; and

FIG. 3 is a flow chart depicting an exemplary method of operating a power system in accordance with embodiments of the disclosure.

### DETAILED DESCRIPTION

Certain details are set forth below to provide a sufficient understanding of various embodiments of the disclosure. However, it will be clear to one skilled in the art that embodiments of the disclosure may be practiced without one or more of these particular details, or with other details. Moreover, the particular embodiments of the present disclosure described herein are provided by way of example and should not be used to limit the scope of the disclosure to these particular embodiments. In other instances, hardware components, network architectures, and/or software operations have not been shown in detail in order to avoid unnecessarily obscuring the disclosure.

In some embodiments, a system (e.g., such as power system 100 described below) includes a facility (e.g., a data center) for storing and processing data that is integrated with a power system that produces fully renewable energy as a dedicated supply to the data center (e.g., the data center is powered solely by the energy generated by the power system). The power system is designed to be capable of satisfying (e.g., completely satisfying) the energy demands of the data center at any time without external sources of energy. The design of the data center is based on a power system with an optimized combination of renewable energy generation as a primary source of power, supported by battery energy storage, and the production and long-term storage of green hydrogen as a fuel for energy generation with gas turbines or fuel cells. When the amount of renewable energy generated by the power system (e.g., via solar and/or wind resources) exceeds the demand of the data center, the residual renewable energy is used to charge a battery energy storage system and/or power a hydrogen production device to produce hydrogen, which is then stored for use by a hydrogen-based energy generator. The stored battery energy and/or stored hydrogen are used to power the data center when renewable energy is unavailable (e.g., due to a lack of solar and/or wind resources) or insufficient to fulfill the demand of the data center. This enabled power to be continuously supplied to the data center without use of non-renewable sources of energy.

In some embodiments, the sources of energy of the power system are geographically correlated with the data center (e.g., the energy sources are located within a threshold distance of the data center). In some embodiments, energy generation by the power system is directly correlated in time with energy consumption by the data center (e.g., the power system adjusts power generation based on energy consumption by the data center). In some embodiments, the power system is solely dedicated to the data center and/or is fully integrated with the electrical system of the data center. In some embodiments, a level of redundancy for a set of operations of the data center (e.g., mission-critical data center operations) is achieved without fossil fuels. In some embodiments, performance metrics and/or objectives of the power system and/or the data center are documented as per regulations for green certification. In some embodiments, performance metrics and/or objectives of the power system and/or the data center satisfy regulations for green certification.

In the disclosure and claims below, use of the terms “first,” “second,” etc. to describe various elements should not be limited by the terms. In some embodiments, these terms are used to distinguish one element from another. For example, a first element could be termed a second element, and, similarly, a second element could be termed a first element, without departing from the scope of the various described embodiments. In some embodiments, the first element and the second element are two separate references to the same element. In some embodiments, the first element and the second element are both elements, but they are not the same element. As used in the description of the various described embodiments and the appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “when” is, optionally, construed to mean “if” or “while” or “upon” or “in response to” or “in response to determining” or “in response to detecting,” depending on the context.

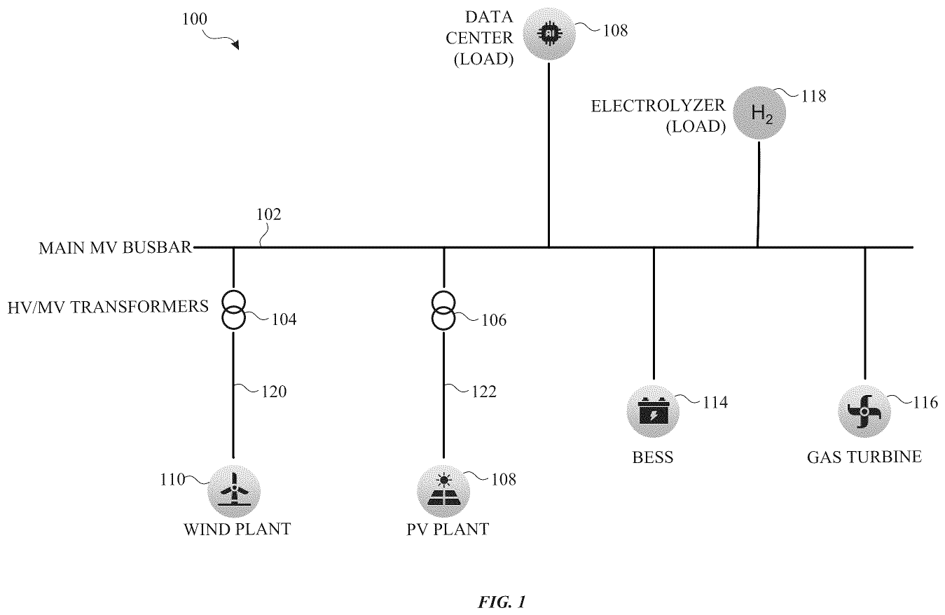

FIG. 1 is a schematic diagram of a power system in accordance with some embodiments. In FIG. 1, power system 100 is represented by a high-level single-line electrical system diagram. Power system 100 includes wind power plant 110, solar photovoltaic (PV) power plant 112, battery energy storage system (BESS) 114, gas turbine generator (GTG) 116 (e.g., a gas turbine generator power plant), electrolyzer 118, and data center 108. Data center 108, electrolyzer 118, battery energy storage system 114, and gas turbine generator 116 are connected directly to main medium voltage (MV) busbar 102. Wind power plant 110 is connected to main MV busbar 102 via high voltage power transmission line 120 and high-voltage-to-medium voltage (HV/MV) transformer 104, and solar PV power plant 112 is connected to main MV busbar 102 via high voltage power transmission line 122 and HV/MV transformer 106. In some embodiments, gas turbine generator 116 includes a green hydrogen gas turbine generator plant. In some embodiments, electrolyzer 118 includes a green hydrogen electrolyzer plant. In some embodiments, electrolyzer 118 includes a reverse osmosis (RO) seawater desalination plant.

In some embodiments, battery energy storage system 114 is a grid-forming system that is connected to main MV busbar 102 and is live whenever power system 100 is active (e.g., battery energy storage system 114 is live at all times). In some embodiments, battery energy storage system 114 regulates a voltage and/or a frequency of power system 100. For example, in some embodiments, in response to a disturbance (e.g., in voltage and/or frequency) in power system 100, battery energy storage system 114 reacts (e.g., instantaneously and/or automatically) to maintain a stable voltage and/or frequency for data center 108 and/or electrolyzer 118.

In some embodiments, solar PV power plant 112 and/or wind power plant 110 are grid-following and are connected to a high-voltage (HV) substation (SS). When solar PV power plant 112 and/or wind power plant 110 are generating power, they supply the loads (e.g., data center 108 and/or electrolyzer 118) directly via the HV SS. Power system 100 is configured for solar PV power plant 112 and/or wind power plant 110 to charge battery energy storage system 114 and to supply energy to electrolyzer 118.

In response to a state of charge (SOC) of battery energy storage system 114 reaching a lower threshold (e.g., a pre-defined lower threshold), gas turbine generator 116 starts operation and supplies the load (e.g., data center 108) while also re-charging battery energy storage system 114 to a state of charge that meets or exceeds an upper threshold (e.g., a state of charge that is adequate to support an uninterrupted power supply). In some embodiments, gas turbine generator 116 includes two or more gas turbines that start sequentially (e.g., based on the demand of the load).

In the embodiment illustrated in FIG. 1, the primary power source of power system 100 is the combined output of the solar PV power plant 112, wind power plant 110, and battery energy storage system 114. Gas turbine generator 116 supplements the primary power source when there is not enough power from the renewable power plants to satisfy the demand of the data center. In some embodiments, gas turbine generator 116 is kept as line-level back-up when there is enough power from the renewable power plants to satisfy the demand of the data center. In some embodiments, gas turbine generator 116 has a distributed redundant configuration. For example, gas turbine generator 116 can be configured to operate with multiple fuel options (e.g., multiple fuel options that are available within a threshold distance of the data center).

In some embodiments, power system 100 includes a circuit-breaker (CBR) for MV busbar 102 that is on (e.g., always on and/or maintained in an on state) when power system 100 is active. Turbines of gas turbine generator 116 can be synchronized on their own circuit breaker, with a voltage of battery energy storage system 114 as the reference for synchronization, but take the voltage and frequency reference from MV busbar 102.

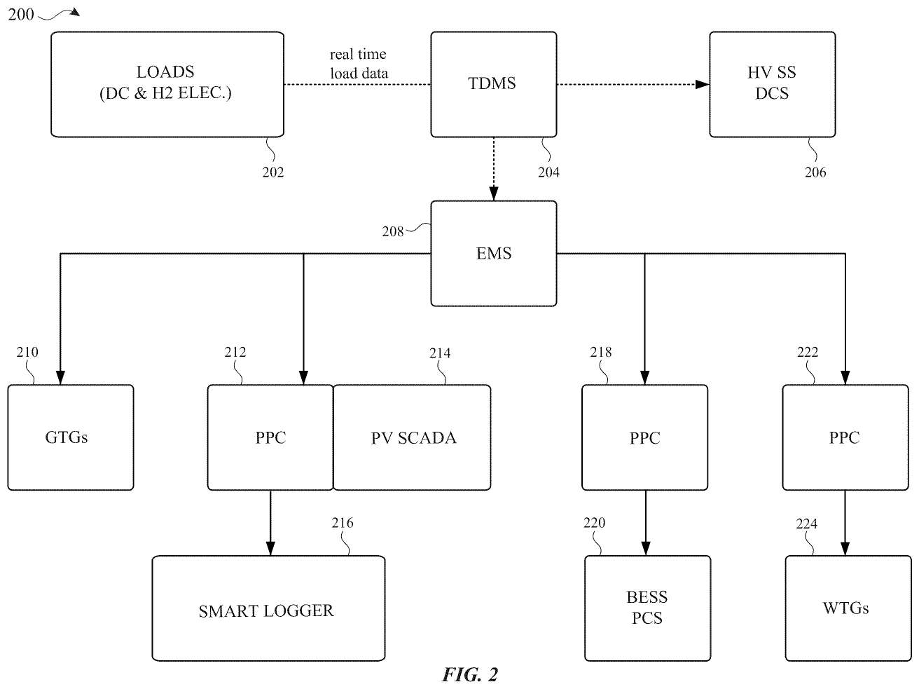

Electrolyzer 118 is switched on when the energy generated by solar PV 112 and/or wind power plant 110 exceeds the demand of both load 108 and battery energy storage system 114. In some embodiments, load shedding of electrolyzer 118 is implemented on the HV level when the energy generated by solar PV 112 and/or wind power plant 110 does not exceed the demand of both load 108 and battery energy storage system 114. In some embodiments, power system 100 includes a transmission and distribution management system (TDMS) (e.g., TDMS 204 shown in FIG. 2) that is configured to control activation of electrolyzer 118 as described above.

In some embodiments, an energy management system (EMS) (e.g., EMS 208 shown in FIG. 2) sends an input signal to either charge or discharge battery energy storage system 114, depending on the control logic requirement, and the state of charge or state of health (SOH) of battery energy storage system 114. In some embodiments, the energy management system (e.g., energy management system 208) balances two or more generation and/or storage resources (e.g., solar PV power plant 112, wind power plant 110, and/or battery energy storage system 114). In some embodiments, the energy management system sends a signal to gas turbine generator 116 to ramp up or ramp down operation of gas turbine generator 116 (e.g., when gas turbine generator 116 is run to meet the total demand of data center 108). In some embodiments, the energy management system is programmed to determine whether battery energy storage system 114 should be charged from energy generated by solar PV power plant 12, wind power plant 110, and/or gas turbine generator 116.

In some embodiments, power system 100 has a medium-voltage and low-voltage (LV) electrical distribution design that is concurrently operable and maintainable with multiple distribution paths. Power system 100 is optionally designed to have electrical redundancy. In some embodiments, data center 108 has electrical redundancy that is achieved by an N+2C (catcher block) without power interruption to server racks and critical services. In some embodiments, power system 100 is designed such that there is no single point of failure for electrical distribution systems serving equipment or a defined set of loads (e.g., essential loads). In some embodiments, power system 100 includes transformer units (e.g., 104 and/or 106) arranged in an MV distribution open ring system with manual transfer. Power system 100 optionally includes a building management system (BMS) that monitors power system 100 and can output an alarm (e.g., in response to detecting an error and/or malfunction in a component or portion of power system 100). In some embodiments, the building management system includes redundant power supplies. In some embodiments, power system 100 meets a requirement to be concurrently operable and maintainable as per Tier III data center standards. In some embodiments, during operations, power system 100 meets Tier III standards (99.982%) of reliability based on the reliability of the selected equipment and the redundancy and concurrently maintainable design elements.

FIG. 2 is a block diagram of a power control system in accordance with some embodiments. Power control system 200 includes load(s) 202, transmission and distribution management system (TDMS) 204, high-voltage sub-station (HV SS) digital control system (DCS) 206, energy management system 208, gas turbine generator 210, power plant controller (PPC) 212, photovoltaic supervisory control and data acquisition (SCADA) system 214, smart logger 216, power plant controller 218, battery energy storage system power converter system (PCS) 220, power plant controller 222, and wind turbine generator (WTG) 224. In some embodiments, gas turbine generator 210 includes two or more gas turbine generators. In some embodiments, wind turbine generator 224 includes two or more wind turbine generators. Some elements of power control system 200 are, optionally, combined, changed, and/or omitted. For example, in some embodiments, loads 202 are omitted from power control system 200 and included in power system 100.

In some embodiments, power system 100 includes power control system 200 or portions thereof (e.g., power control system 200 or portions thereof, are integrated into power system 100). In some embodiments, power control system 200 (or portions thereof) are configured to control power system 100. In some embodiments, load(s) 202 include data center 108 and/or electrolyzer 118. In some embodiments, gas turbine generator 210 includes gas turbine generator 116. In some embodiments, wind turbine generator 224 includes wind power plant 110. Load(s) 202 are connected (e.g., directly connected) to TDMS 204, and TDMS 204 receives real-time load data from load(s) 202. TDMS 204 is connected (e.g., directly connected) to HV SS DCS 206, which receives data from TDMS 204. Energy management system 208 is connected (e.g., directly connected) to TDMS 204 and receives data from TDMS 204. In some embodiments, TDMS 204 is configured to control activation of a hydrogen production device (e.g., electrolyzer 118) as described above.

Energy management system 208 is connected (e.g., directly connected) to gas turbine generator 210, power plant controller 212, power plant controller 218, and power plant controller 222. Energy management system 208 is configured to send signals (e.g., control commands) to gas turbine generator 210, power plant controller 212, power plant controller 218, and power plant controller 222.

In some embodiments, the energy management system (e.g., energy management system 208) balances two or more generation and/or storage resources (e.g., solar PV power plant 112, wind power plant 110, and/or battery energy storage system 114). In some embodiments, energy management system 208 sends an input signal to either charge or discharge the battery energy storage system (e.g., battery energy storage system 114), depending on the control logic requirement, and the state of charge or state of health of the battery energy storage system. In some embodiments, the energy management system sends a signal to gas turbine generator 210 to ramp up or ramp down operation of gas turbine generator 210 (e.g., when gas turbine generator 116 is run to meet the total demand of data center 108). In some embodiments, the energy management system is programmed to determine whether battery energy storage system 114 should be charged from energy generated by solar PV power plant 112, wind power plant 110, and/or gas turbine generator 116.

PV SCADA system 214 and smart logger 216 are connected (e.g., directly connected) to power plant controller 212, battery energy storage system power converter system 220 is connected (e.g., directly connected) to power plant controller 218, and wind turbine generator 224 is connected (e.g., directly connected) to power plant controller 222. Smart logger 216 receives data (e.g., control signals) from power plant controller 212, battery energy storage system power converter system 220 receives data (e.g., control signals) from power plant controller 218, and wind turbine generator 224 receives data (e.g., control signals) from power plant controller 222.

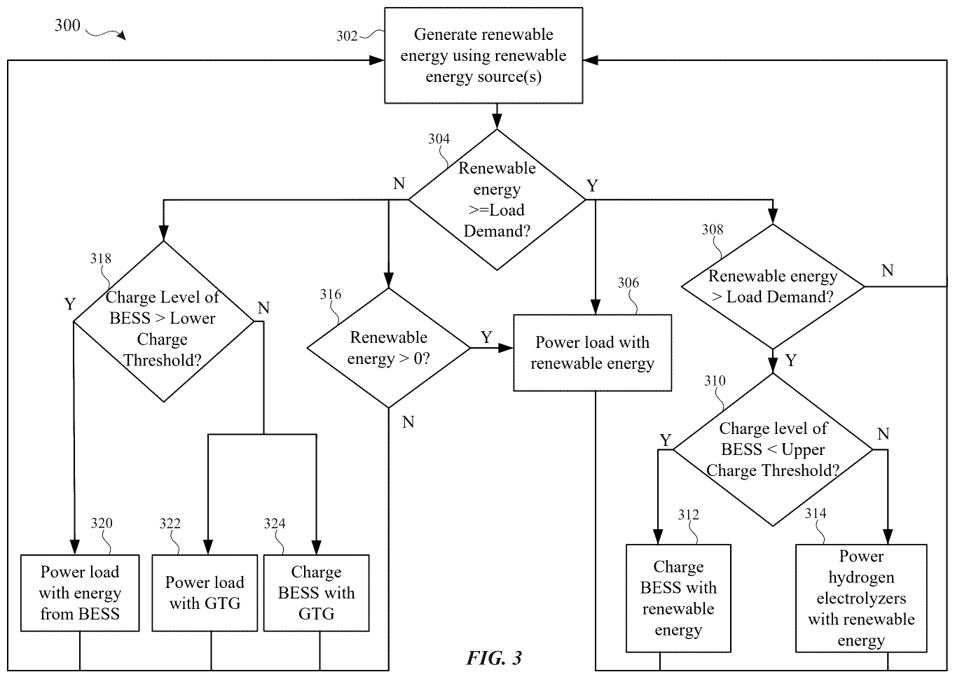

FIG. 3 illustrates a flow chart depicting a method 300 of operation for a power system, according to some embodiments. Method 300 is performed at a power system (e.g., 100 and/or 200) that includes a renewable energy source (e.g., 110 and/or 112), a battery energy storage system (e.g., battery energy storage system 114), a hydrogen production device (e.g., a hydrogen electrolyzer 118), and a hydrogen-based energy generator (e.g., one or more gas turbine generators, such as gas turbine generator 116, and/or one or more hydrogen fuel cells), and a load (e.g., data center 108). Some operations in method 300 are, optionally, combined, the orders of some operations are, optionally, changed, and some operations are, optionally, omitted.

According to method 300, renewable energy is generated at block 302 by the renewable energy source. In some embodiments, the renewable energy is generated by a single (e.g., only one) renewable energy source. In some embodiments, the renewable energy is generated by two or more renewable energy sources. In some embodiments, the renewable energy includes a combination of energy generated by one or more solar photovoltaic power plants and energy generated by one or more wind power plants.

If the renewable energy generated using the renewable energy source is greater than or equal to a demand of a load (e.g., at block 304), then the load is powered using the renewable energy at block 306 (e.g., the renewable energy is supplied to the load). In some embodiments, if the renewable energy generated using the renewable energy source is greater than or equal to the demand of the load, then the load is powered exclusively using the renewable energy (e.g., without energy from the battery energy storage system and without energy from the hydrogen-based energy generator).

If the renewable energy generated using the renewable energy source is equal to the demand of the load, then method 300 proceeds from powering the load with the renewable energy at block 306 to generating renewable energy using the renewable energy source at block 302.

If the renewable energy generated using the renewable energy source is greater than the demand of the load at block 308 and a charge level (e.g., a state of charge) of the battery energy storage system is less than an upper charge threshold at block 310 (e.g., the battery energy storage system is not fully charged and/or is not charged to a predetermined level), then the battery energy storage system is charged with the renewable energy generated using the renewable energy source at block 312. For example, once the demand of the load is fully met using the renewable energy generated using the renewable energy source, an excess amount of the renewable energy is used to charge the battery energy storage system if the charge level of the battery energy storage system is below an upper charge threshold.

If the renewable energy generated using the renewable energy source is greater than the demand of the load at block 308 and the charge level of the battery energy storage system satisfies (e.g., is greater than or equal to) the upper charge threshold at block 310 (e.g., the battery energy storage system is fully charged and/or is charged to a predetermined level), then the hydrogen-based energy generator is powered with the renewable energy generated using the renewable energy source at block 314. Powering the hydrogen-based energy generator causes the hydrogen-based energy generator to produce hydrogen, which is stored for later use (e.g., when the renewable energy generated using the renewable energy source is less than the demand of the load). For example, once the demand of the load is fully met using the renewable energy generated using the renewable energy source, an excess amount of the renewable energy is used to power the hydrogen-based energy generator if the charge level of the BESS is at or above an upper charge threshold.

Accordingly, the renewable energy is primarily used to supply the demand of the load and then, if there is excess energy after supplying the load, the excess energy is used to either charge the battery energy storage system or power the hydrogen-based energy generator, depending on the charge level of the battery energy storage system (e.g., whether the battery energy storage system is sufficiently charged).

Returning to block 304, if the renewable energy generated using the renewable energy source is less than the demand of the load at block 304 and the renewable energy generated using the renewable energy source is greater than zero at block 316 (e.g., the renewable energy source produces as least some energy), then the load is powered using the renewable energy at block 306.

If the renewable energy generated using the renewable energy source is less than the demand of the load at block 304 and the charge level of the battery energy storage system is greater than a lower charge threshold (e.g., a minimum charge level), then the load is powered using energy from the battery energy storage system. For example, energy from the battery energy storage system is used to supply the remaining demand of the load that is not met by the renewable energy generated using the renewable energy source.

If the renewable energy generated using the renewable energy source is less than the demand of the load at block 304 and the charge level of the battery energy storage system is less than or equal to the lower charge threshold (e.g., the battery energy storage system is not charged and/or has a current charge below a threshold level), then the load is powered using energy from the hydrogen-based energy generator and the battery energy storage system is charged using energy from the hydrogen-based energy generator. For example, energy from the hydrogen-based energy generator is used to supply the remaining demand of the load that is not met by the renewable energy generated using the renewable energy source.

In some embodiments, the battery energy storage system is charged using energy generated using the hydrogen-based energy generator if the energy generated using the hydrogen-based energy generator is greater than the demand of the load that is not met by the renewable energy. In some embodiments, the battery energy storage system is charged with an amount of energy generated using the hydrogen-based energy generator that exceeds the demand of the load that is not met by the renewable energy.

According to some embodiments, a power system (e.g., 100) comprises a renewable energy source (e.g., 110, 112, a solar photovoltaic power plant, and/or a wind power plant), a battery energy storage system (e.g., 114), a hydrogen production device (e.g., 118, a hydrogen generator, and/or a hydrogen electrolyzer), a hydrogen-based energy generator (e.g., 115, a hydrogen gas turbine generator and/or a hydrogen fuel cell), and a load (e.g., 108 and/or a data center). In some embodiments, the load includes a data center. In some embodiments, a data center is a centralized physical facility that includes information technology (IT) infrastructure configured to build, run, and/or deliver applications and/or services, and/or for storing and/or managing data associated with the applications and/or services. In some embodiments, the data center includes computing devices such as, e.g., servers, routers, switches, and/or firewalls. In some embodiments, the data center includes backup equipment, fire suppression facilities, air conditioning, and/or other supporting components.

In some embodiments, the renewable energy source includes a solar photovoltaic power plant. In some embodiments, the renewable energy source includes a wind power plant. In some embodiments, the wind power plant includes one or more wind turbine generators. In some embodiments, the renewable energy source does not include an engine (e.g., an internal combustion engine). In some embodiments, the renewable energy source does not include an uninterruptible power supply.

In some embodiments, the hydrogen production device includes a hydrogen electrolyzer. In some embodiments, a hydrogen electrolyzer uses electricity to split water into hydrogen and oxygen. In some embodiments, hydrogen produced by the hydrogen production device is stored and/or used as clean fuel or a chemical reactant (e.g., by the hydrogen-based energy generator). In some embodiments, the hydrogen production device includes a reverse osmosis seawater desalination system. In some embodiments, the hydrogen-based energy generator is a system or device that generates energy (e.g., electrical energy) using hydrogen (e.g., hydrogen gas) as fuel. In some embodiments, the hydrogen-based energy generator is configured to operate using hydrogen produced by the hydrogen production device.

The power system is configured to generate renewable energy using the renewable energy source (e.g., 302). In some embodiments, the renewable energy includes electricity, electrical charge, and/or electrical power. In some embodiments, a magnitude of the renewable energy is based on an amount of a renewable energy resource (e.g., sunlight and/or wind) corresponding to the renewable energy source. In some embodiments, the magnitude of the renewable energy is zero (e.g., the renewable energy source does not generate any energy) when the renewable energy resource corresponding to the renewable energy source is below a threshold level (e.g., when an amount of sunlight is below a threshold level for a solar photovoltaic power plant and/or when an amount of wind is below a threshold level for a wind power plant).

The power system is configured to power (e.g., at 306) the load with the renewable energy generated by the renewable energy source (e.g., based on a magnitude of the renewable energy and/or a demand of the load). In some embodiments, the power system is configured to power the load with the renewable energy generated by the renewable energy source when a set of conditions is satisfied (e.g., 304 is “Yes” and/or 316 is “Yes”). In some embodiments, the set of conditions is satisfied when the renewable energy generated by the renewable energy source is greater than zero and a demand of the load is greater than zero. In some embodiments, the power system is configured to not power the load with renewable energy generated by the renewable energy source when the set of conditions is not satisfied. In some embodiments, the set of conditions is not satisfied when the renewable energy generated by the renewable energy source is zero or the demand of the load is zero. In some embodiments, the renewable energy generated by the renewable energy source is the primary source of energy for powering the load. In some embodiments, the power system is not configured to power the load with energy other than energy from the renewable energy source, the batter energy storage system, and/or the hydrogen-based energy generator (e.g., the power system does not power the load with energy from outside the power system). For example, in some embodiments, the power system is a closed system. In some embodiments, the power system is not configured to supply power to a load outside the power system (e.g., to a load other than the load of the power system or the hydrogen production system). In some embodiments, the load is powered with a first portion (e.g., less than all) of the renewable energy generated using the renewable energy source.

The power system is configured to perform (e.g., conditionally perform) the following operations (e.g., charging the battery energy storage system with the renewable energy generated by the renewable energy source and powering the hydrogen production device with energy generated by the renewable energy source) based on the renewable energy compared to a demand of the load (e.g., when the renewable energy is greater than a demand of the load, when block 308 is “Yes”, and/or when a magnitude of the renewable energy generated by the renewable energy source is greater than a demand of the load) and/or based on a charge level of the battery energy storage system (e.g., compared to an upper threshold charge level). In some embodiments, the demand of the load is an energy demand, a power demand, an electricity demand, a current demand, an instantaneous demand, a predicted demand, an estimated demand, and/or a future demand. For example, when the renewable energy is greater than a demand of the load and a charge level (e.g., a state of charge) of the battery energy storage system does not satisfy (e.g., is less than) an upper threshold charge level (e.g., 310 is “Yes” and/or when the charge level of the battery energy storage system is below the upper threshold charge level), the power system charges (e.g., at 312) the battery energy storage system with the renewable energy generated by the renewable energy source. Alternatively, when the renewable energy is greater than a demand of the load and the charge level of the battery energy storage system satisfies the upper threshold charge level (e.g., 310 is “No” and/or when the charge level of the battery energy storage system is greater than or equal to the upper threshold charge level and/or when the battery energy storage system is determined to be fully charged), the power system powers (e.g., 314) the hydrogen production device with energy generated by the renewable energy source.

In some embodiments, the power system is configured to charge the battery energy storage system without powering the hydrogen production device. In some embodiments, the power system is configured to concurrently charge the battery energy storage system and power the load with the renewable energy generated by the renewable energy source when the renewable energy exceeds the demand of the load. In some embodiments, the power system is configured to charge the battery energy storage system without powering the hydrogen production device. In some embodiments, the power system is configured to concurrently charge the battery energy storage system and power the hydrogen production device when the renewable energy exceeds the demand of the load. In some embodiments, a second portion of the renewable energy generated by the renewable energy source is used to charge the battery energy storage system (e.g., excess energy that is available beyond the energy used to power the load).

In some embodiments, powering the hydrogen production device includes supplying energy to the hydrogen production device. In some embodiments, powering the hydrogen production device causes the hydrogen production device to produce hydrogen gas. In some embodiments, a second portion of the renewable energy generated by the renewable energy source is used to power the hydrogen production device (e.g., excess energy that is available beyond the energy used to power the load).

The power system is configured to perform (e.g., conditionally perform) the following operations (e.g., powering the load with energy from the battery energy storage system, powering the load with energy generated by the hydrogen-based energy generator, and/or charging the battery energy storage system with energy generated by the hydrogen-based energy generator) based on the renewable energy and the demand of the load (e.g., when the renewable energy is less than the demand of the load, when block 304 is “No”, and/or when a magnitude of the renewable energy generated by the renewable energy source is less than the demand of the load) and/or based on the charge level of the battery energy storage system (e.g., compared to a lower threshold charge level). For example, when the renewable energy is less than the demand of the load and the charge level of the battery energy storage system satisfies (e.g., is greater than) a lower threshold charge level (e.g., 318 is “Yes” and/or when the charge level of the battery energy storage system is above the lower threshold charge level), the power system powers (e.g., 320) the load with energy from the battery energy storage system. Alternatively, when the renewable energy is less than the demand of the load and the charge level of the battery energy storage system does not satisfy (e.g., is less than) the lower threshold charge level (e.g., 318 is “No” and/or when the charge level of the battery energy storage system is at or below the lower threshold charge level), the power system powers (e.g., 322) the load with energy generated by the hydrogen-based energy generator and charges (e.g., 324) the battery energy storage system with energy generated by the hydrogen-based energy generator. In some embodiments, the lower threshold charge level is less than the upper threshold charge level. In some embodiments, the lower threshold charge level is a value in the range of 10%-30% (e.g., of maximum charge capacity).

In some embodiments, the battery energy storage system powers the load with an amount of energy that is sufficient to meet the demand of the load when combined with the renewable energy generated by the renewable energy source (e.g., the battery energy storage system supplies the balance of the demand of the load after renewable energy is exhausted). In some embodiments, powering the load with energy generated by the hydrogen-based energy generator includes operating (e.g., activating and/or powering on) the hydrogen-based energy generator using hydrogen produced by the hydrogen production device. In some embodiments, charging the battery energy storage system with energy generated by the hydrogen-based energy generator includes charging the battery energy storage system with energy generated by the hydrogen-based energy generator until the charge level of the battery energy storage system satisfies (e.g., is greater than or equal to) a third threshold charge level (e.g., the upper threshold charge level or a charge level between the lower threshold charge level and the upper threshold charge level).

In some embodiments, the renewable energy is not used to charge the battery energy storage system when the renewable energy is less than the demand of the load. In some embodiments, powering a load or a device includes suppling the load or device, respectively, with energy (e.g., electricity and/or electrical energy). In some embodiments, charging the battery energy storage system includes supplying the battery energy storage system with energy.

In some embodiments, the power system comprises a hydrogen storage system and is configured to store hydrogen produced by the hydrogen production device in the hydrogen storage system. In some embodiments, the hydrogen-based energy generator generates energy (e.g., to power the load and/or charge the battery energy storage system) using hydrogen stored in the hydrogen storage system.

In some embodiments, the power system is configured to power the load using the energy generated by the renewable energy source without charging the battery energy storage system and without powering the hydrogen production device when a magnitude of the renewable energy generated by the renewable energy source matches (e.g., is equal to) a demand of the load.

In some embodiments, the power system comprises an energy management system (e.g., 208) connected to the renewable energy source, the hydrogen-based energy generator, and the battery energy storage system. In some embodiments, the energy management system is connected to the renewable energy source via a power plant controller (e.g., 212, 218, 222, and/or a system that controls operation of the renewable energy source). In some embodiments, the energy management system determines whether or not the set of conditions is satisfied and/or whether the renewable energy is greater than or less than the demand of the load. In some embodiments, the energy management system determines whether the charge level of the battery energy storage system satisfies the upper threshold charge level and/or whether the charge level of the battery energy storage system satisfies the lower threshold charge level. In some embodiments, the power system comprises a transmission and distribution management system (e.g., 204). In some embodiments, the transmission and distribution management system determines whether or not the set of conditions is satisfied and/or whether the renewable energy is greater than or less than the demand of the load. In some embodiments, the transmission and distribution management system determines whether the charge level of the battery energy storage system satisfies the upper threshold charge level and/or whether the charge level of the battery energy storage system satisfies the lower threshold charge level. In some embodiments, the transmission and distribution management system is in communication with the load and the energy management system. In some embodiments, the transmission and distribution management system receives real time load data from the load. In some embodiments, the transmission and distribution management system sends real time load data to the energy management system and/or a high voltage substation. In some embodiments, the energy management system controls the renewable energy source, the battery energy storage system, and/or the hydrogen-based energy generator based on the load data received from the transmission and distribution management system.

In some embodiments, the power system comprises a high-voltage power transmission line (e.g., 120 and/or 122) connected to the renewable energy source. In some embodiments, the high-voltage power transmission line includes a dedicated power corridor and a substation. In some embodiments, the renewable energy source is connected directly to the high-voltage power transmission line. In some embodiments, the renewable energy source powers the load, powers the hydrogen production device, and/or charges the battery energy storage system via the high-voltage power transmission line.

In some embodiments, the power system comprises a medium voltage busbar (e.g., 102) connected to the load, the hydrogen production device, the battery energy storage system, and the hydrogen-based energy generator. In some embodiments, the load, the hydrogen production device, the battery energy storage system, and the hydrogen-based energy generator are directly connected to the medium voltage busbar. In some embodiments, the load, the hydrogen production device, and the hydrogen-based energy generator are powered via the medium voltage busbar. In some embodiments, the battery energy storage system is charged via the medium voltage busbar. In some embodiments, the renewable energy source is connected to the medium voltage busbar via the high-voltage power transmission line (e.g., and a high-voltage to medium-voltage transformer, such as 104 and/or 106).

According to some embodiments of a power system (e.g., 100), a renewable energy source (e.g., 110 and/or 112) is configured to power a load (e.g., 108) and selectively charge a battery energy storage system (e.g., 114) and power a hydrogen production device (e.g., 118). In some embodiments, the renewable energy source is configured to selectively charge the battery energy storage system and power the hydrogen production device based on the demand of the load compared to the amount of energy generated by the renewable energy source and/or based on a charge level of the battery energy storage system relative to an upper threshold (e.g., as described in method 300). The battery energy storage system is configured to power the load (e.g., based on the demand of the load compared to the amount of energy generated by the renewable energy source and/or based on the charge level of the battery energy storage system relative to a lower threshold as described in method 300). A hydrogen-based energy generator (e.g., 116) is configured to power the load and/or charge the battery energy storage system (e.g., based on the demand of the load compared to the amount of energy generated by the renewable energy source and/or based on the charge level of the battery energy storage system relative to a lower threshold as described in method 300).

According to some embodiments, a power system (e.g., 100) is configured to power a load (e.g., 108) using energy (e.g., available energy) generated by a renewable energy source (e.g., 110 and/or 112). The power system is configured to selectively charge a battery energy storage system (e.g., 114) and power a hydrogen production device (e.g., 118) using energy (e.g., excess energy) generated by the renewable energy source. The power system is configured to selectively charge the battery energy storage system and power the hydrogen production device using energy generated by the renewable energy source (e.g., based on the demand of the load compared to the amount of energy generated by the renewable energy source and/or based on a charge level of the battery energy storage system relative to an upper threshold, as described in method 300). The power system is configured to power the load using energy (e.g., balance energy) from the battery energy storage system (e.g., based on the demand of the load compared to the amount of energy generated by the renewable energy source and/or based on the charge level of the battery energy storage system relative to a lower threshold as described in method 300). The power system is configured to activate a hydrogen-based energy generator (e.g., 116) and power the load and/or charge the battery energy storage system using energy (e.g., standby energy) generated by the hydrogen-based energy generator (e.g., based on the demand of the load compared to the amount of energy generated by the renewable energy source and/or based on the charge level of the battery energy storage system relative to a lower threshold as described in method 300).

The foregoing description, for purposes of explanation, used specific nomenclature to provide a thorough understanding of the disclosure. However, it will be apparent to one skilled in the art that the specific details are not required to practice the methods and systems of the disclosure. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, any performance metrics and variables may be determined from sensor or other input data, in any manner. Further, these metrics and variables, and their correlations, may be represented in any form compatible with a chatbot or other computer-based agent. The embodiments were chosen and described in order to best explain the principles of the invention and its practical applications, to thereby enable others skilled in the art to best utilize the methods and systems of the disclosure and various embodiments with various modifications as are suited to the particular use contemplated. Additionally, different features of the various embodiments, disclosed or otherwise, can be mixed and matched or otherwise combined so as to create further embodiments contemplated by the disclosure.

What is claimed is:

1. A power system, comprising:
a renewable energy source;
a battery energy storage system;
a hydrogen production device;
a hydrogen-based energy generator; and
a load,
the power system configured to:
generate renewable energy using the renewable energy source;
power the load with the renewable energy generated by the renewable energy source when a set of conditions is satisfied;
when the renewable energy is greater than a demand of the load:
charge the battery energy storage system with the renewable energy generated by the renewable energy source when a charge level of the battery energy storage system does not satisfy an upper threshold charge level; and
power the hydrogen production device with energy generated by the renewable energy source when the charge level of the battery energy storage system satisfies the upper threshold charge level; and
when the renewable energy is less than the demand of the load:
power the load with energy from the battery energy storage system when the charge level of the battery energy storage system satisfies a lower threshold charge level; and
when the charge level of the battery energy storage system does not satisfy the lower threshold charge level:
power the load with energy generated by the hydrogen-based energy generator; and
charge the battery energy storage system with energy generated by the hydrogen-based energy generator.

2. The power system of claim 1, wherein the set of conditions is satisfied when the renewable energy generated by the renewable energy source is greater than zero and a demand of the load is greater than zero.

3. The power system of claim 1, wherein the load includes a data center.

4. The power system of claim 1, wherein the renewable energy source includes a solar photovoltaic power plant.

5. The power system of claim 1, wherein the renewable energy source includes a wind power plant.

6. The power system of claim 1, wherein the hydrogen production device includes a hydrogen electrolyzer.

7. The power system of claim 1, wherein the hydrogen production device includes a reverse osmosis seawater desalination system.

8. The power system of claim 1, wherein the hydrogen-based energy generator is configured to operate using hydrogen produced by the hydrogen production device.

9. The power system of claim 1, further comprising a hydrogen storage system, wherein the power system is configured to store hydrogen produced by the hydrogen production device in the hydrogen storage system.

10. The power system of claim 1, wherein the power system is configured to power the load using the energy generated by the renewable energy source without charging the battery energy storage system and without powering the hydrogen production device when a magnitude of the renewable energy generated by the renewable energy source matches a demand of the load.

11. The power system of claim 1, further comprising an energy management system connected to the renewable energy source, the hydrogen-based energy generator, and the battery energy storage system.

12. The power system of claim 11, wherein the energy management system is connected to the renewable energy source via a power plant controller.

13. The power system of claim 1, further comprising a transmission and distribution management system.

14. The power system of claim 13, wherein the transmission and distribution management system is in communication with the load and the energy management system.

15. The power system of claim 1, further comprising a high-voltage power transmission line connected to the renewable energy source.

16. The power system of claim 15, further comprising a medium voltage busbar connected to the load, the hydrogen production device, the battery energy storage system, and the hydrogen-based energy generator.

17. A method of operating a power system, comprising:
generating renewable energy using a renewable energy source;
powering a load with the renewable energy generated by the renewable energy source when a set of conditions is satisfied;
when the renewable energy is greater than a demand of the load:
charging a battery energy storage system with the renewable energy generated by the renewable energy source when a charge level of the battery energy storage system does not satisfy an upper threshold charge level; and
powering a hydrogen production device with energy generated by the renewable energy source when the charge level of the battery energy storage system satisfies the upper threshold charge level; and
when the renewable energy is less than the demand of the load:
powering the load with energy from the battery energy storage system when the charge level of the battery energy storage system satisfies a lower threshold charge level; and
when the charge level of the battery energy storage system does not satisfy the lower threshold charge level:
powering the load with energy generated by a hydrogen-based energy generator; and
charging the battery energy storage system with energy generated by the hydrogen-based energy generator.

18. The method of claim 17, further comprising:
storing hydrogen produced by the hydrogen production device in a hydrogen storage system.

19. The method of claim 17, further comprising:
powering the load using the energy generated by the renewable energy source without charging the battery energy storage system and without powering the hydrogen production device when a magnitude of the renewable energy generated by the renewable energy source matches a demand of the load.

20. A control system, comprising:
one or more processors;
memory; and
one or more programs, wherein the one or more programs are stored in the memory and configured to be executed by the one or more processors, the one or more programs including instructions for:
causing powering of a load with renewable energy generated by a renewable energy source when a set of conditions is satisfied;
when the renewable energy is greater than a demand of the load:
causing charging of a battery energy storage system with the renewable energy generated by the renewable energy source when a charge level of the battery energy storage system does not satisfy an upper threshold charge level; and
causing powering of a hydrogen production device with energy generated by the renewable energy source when the charge level of the battery energy storage system satisfies the upper threshold charge level; and
when the renewable energy is less than the demand of the load:
causing powering of the load with energy from the battery energy storage system when the charge level of the battery energy storage system satisfies a lower threshold charge level; and
when the charge level of the battery energy storage system does not satisfy the lower threshold charge level:
causing powering of the load with energy generated by a hydrogen-based energy generator; and
causing charging of the battery energy storage system with energy generated by the hydrogen-based energy generator.
